(19) United States
(12) Patent Application Publication
(10) Pub. No.: US 2026/0025577 A1
(43) Pub. Date: Jan. 22, 2026

(54) IMAGING APPARATUS, METHOD, AND PROGRAM

(71) Applicant: FUJIFILM Corporation, Tokyo (JP)

(72) Inventors: Shota SUGAYA, Saitama-shi (JP); Kentaro IMAGAWA, Saitama-shi (JP); Daisuke TONAI, Saitama-shi (JP); Toshiaki NAGAI, Saitama-shi (JP)

(73) Assignee: FUJIFILM Corporation, Tokyo (JP)

(21) Appl. No.: 19/275,182

(22) Filed: Jul. 21, 2025

(30) Foreign Application Priority Data
Jul. 22, 2024 (JP) 2024-116794

(51) Int. Cl. H04N 23/667; G03B 7/24

(52) U.S. Cl. CPC H04N 23/667; G03B 7/24

(57) ABSTRACT

An imaging apparatus includes a controller and is capable of executing a film camera mode. The controller acquires first information related to insertion and removal of a memory card in which imaging data of the imaging apparatus is recorded. The controller restricts the film camera mode related to a function of the imaging apparatus based on the first information.

### CROSS-REFERENCE TO RELATED APPLICATIONS

This application claims priority under 35 U.S.C § 119 (a) to Japanese Patent Application No. 2024-116794 filed on 22 Jul. 2024. The above applications are hereby expressly incorporated by reference, in its entirety, into the present application.

### BACKGROUND OF THE INVENTION

### 1. Field of the Invention

The present disclosure relates to an imaging apparatus, a method, and a program.

### 2. Description of the Related Art

According to JP4253086B (corresponding to US2007/0127913A1), there is provided a dummy-imaging mode in which, in a case where a PC card not being mounted is detected, image data is stored only in a buffer memory and the image data is not recorded in the PC card.

According to JP2003-78806A, in a case where a captured image count reaches a remaining capture count, imaging is disabled even in a case where a shutter release button is pushed to perform imaging.

According to JP5057135B, a write flag is read out from a built-in memory, and whether or not a processing image corresponding to a reproduction target is recorded in the built-in memory is determined based on the write flag.

### SUMMARY OF THE INVENTION

An object of an exemplary embodiment of the invention is to provide an imaging apparatus, a method, and a non-transitory computer readable medium for storing a program that enable experience of an analog imaging operation in a state where a film is removed in a film camera.

An imaging apparatus according to an aspect of the exemplary embodiment comprises a processor, in which the processor is configured to acquire first information related to insertion and removal of a recording medium on which imaging data of the imaging apparatus is recorded, and restrict a first imaging mode related to a function of the imaging apparatus based on the first information.

It is preferable that, in a case where the first imaging mode is started, the processor is configured to perform a first control that is a control of any of executing the first imaging mode or restricting the first imaging mode, based on the first information. It is preferable that, in a case where the first imaging mode is executed, the processor is configured to output error information based on the first information. It is preferable that, after the error information is output, the processor is configured to perform a second control that is a control of any of continuing the first imaging mode or restricting the first imaging mode, based on the first information.

It is preferable that, in a case where the first imaging mode is executed, and the imaging apparatus is powered off and then, powered on again, the processor is configured to perform a third control that is a control of any of continuing the first imaging mode or restricting the first imaging mode, based on the first information.

It is preferable that, in a case where the first imaging mode is finished, the processor is configured to perform initialization related to the first imaging mode. It is preferable that the initialization is processing of not using a first set value set in first imaging in the first imaging mode as a second set value set in second imaging that is imaging in the subsequent first imaging mode. It is preferable that, in a case where the first imaging mode is finished, the processor is configured to execute a second imaging mode in which imaging different from imaging in the first imaging mode is performed.

It is preferable that the first imaging mode is an imaging mode in which a captured image count is restricted. It is preferable that the first imaging mode is an imaging mode in which image formats are restricted. It is preferable that the first imaging mode is an imaging mode in which the processor is configured to restrict output of a live view to a monitor portion. It is preferable that the first imaging mode is an imaging mode in which storage of a series of image data obtained by imaging in the first imaging mode in a format other than a single unit format is restricted. It is preferable that the first information is information including a state of the insertion and removal of the recording medium.

It is preferable that the processor is configured to, in a case where the first information indicates an insertion state of the recording medium, execute the first imaging mode, and in a case where the first information indicates a removal state of the recording medium, restrict the first imaging mode. It is preferable that the processor is configured to determine presence or absence of a first attribute assigned to the recording medium by executing the first imaging mode, and continue the first imaging mode in a case where the first attribute is present, and restrict the first imaging mode in a case where the first attribute is absent.

It is preferable that the processor is configured to determine presence or absence of a first attribute assigned to the recording medium by executing the first imaging mode, continue the first imaging mode in a case where the first attribute is present and an external change is not made to a second attribute assigned to data of the recording medium in association with a history record, and restrict the first imaging mode in a case where the first attribute is present and an external change is made to the second attribute assigned to the data of the recording medium in association with the history record.

It is preferable that the processor is configured to, in a case where the imaging apparatus is powered off and then, powered on again, determine presence or absence of a first attribute assigned to the recording medium by executing the first imaging mode, and continue the first imaging mode in a case where the first attribute is present, and restrict the first imaging mode in a case where the first attribute is absent.

It is preferable that the processor is configured to, in a case where the imaging apparatus is powered off and then, powered on again, determine presence or absence of a first attribute assigned to the recording medium by executing the first imaging mode, continue the first imaging mode in a case where the first attribute is present and an external change is not made to a second attribute assigned to data of the recording medium in association with a history record, and restrict the first imaging mode in a case where the first attribute is present and an external change is made to the second attribute assigned to the data of the recording medium in association with the history record.

An imaging apparatus according to another aspect of the exemplary embodiment comprises a processor, in which the processor is configured to, in a case where a recording medium is inserted, acquire second information related to an attribute of the recording medium, and restrict a first imaging mode related to a function of the imaging apparatus based on the second information.

It is preferable that the attribute includes any of a first attribute assigned to the recording medium by executing the first imaging mode or a second attribute assigned to data of the recording medium in association with a history record.

An imaging method according to still another aspect of the exemplary embodiment comprises, via a processor of an imaging apparatus, acquiring first information related to insertion and removal of a recording medium on which imaging data of the imaging apparatus is recorded, and restricting a first imaging mode related to a function of the imaging apparatus based on the first information.

A non-transitory computer readable medium according to still another aspect of the exemplary embodiment stores a program causing a processor of an imaging apparatus to execute a process comprising acquiring first information related to insertion and removal of a recording medium on which imaging data of the imaging apparatus is recorded, and restricting a first imaging mode related to a function of the imaging apparatus based on the first information.

According to the exemplary embodiment of the invention, an analog imaging operation in a state where a film is removed in a film camera can be experienced.

### BRIEF DESCRIPTION OF THE DRAWINGS

FIG. 1 is a front perspective view of an imaging apparatus.

FIG. 2 is a rear perspective view of the imaging apparatus.
(A) of FIG. 3 is a descriptive diagram illustrating a position of a lever in a case where the imaging apparatus is powered off, (B) of FIG. 3 is a descriptive diagram illustrating a correct position of the lever in a case where the imaging apparatus is powered on, and (C) of FIG. 3 is a descriptive diagram illustrating a maximum rotational position of the lever during a winding operation.

FIG. 4 is a block diagram illustrating a schematic configuration of the imaging apparatus.
(A) of FIG. 5 is an image diagram of a display displaying a screen of a normal mode, and (B) of FIG. 5 is a diagram of an image of the display displaying a screen of a film camera mode.

FIG. 6 is an image diagram of the display displaying a detailed screen of the film camera mode.
(A) of FIG. 7 is a descriptive diagram illustrating a screen of a touch operation disabled region immediately after the film camera mode is started, (B) of FIG. 7 is a descriptive diagram illustrating a screen of the touch operation disabled region during the winding operation, and (C) of FIG. 7 is a descriptive diagram illustrating a screen of the touch operation disabled region after an imaging operation is completed.

FIG. 8 is a rear view of the imaging apparatus in a case where the imaging operation is performed while a lock is set on the imaging operation.

FIG. 9 is an image diagram of the display in a case where the imaging operation is performed while the lock is set on the imaging operation.
(A) of FIG. 10 is an image diagram of the display displaying a screen during the film camera mode, (B) of FIG. 10 is an image diagram of the display displaying a film camera mode finish selection screen, and (C) of FIG. 10 is an image diagram of the display displaying a normal screen.
(A) of FIG. 11 is an image diagram of the display displaying a screen during the film camera mode, (B) of FIG. 11 is an image diagram of the display displaying a film camera mode finish screen, and (C) of FIG. 11 is an image diagram of the display displaying the normal screen.

FIG. 12 is a descriptive diagram illustrating a thumbnail image diagram.

FIG. 13 is a table showing modes 1 to 10 of the film camera mode.

FIG. 14A is a descriptive diagram illustrating a case where the film camera mode is executed, and FIG. 14B is a descriptive diagram illustrating a case where the film camera mode is finished.

FIG. 15 is a table showing a case of executing the film camera mode and a case of finishing the film camera mode based on first information.

FIG. 16A is a descriptive diagram illustrating a case of continuing the film camera mode after outputting error information, and FIGS. 16B and 16C are descriptive diagrams illustrating a case of finishing the film camera mode after outputting the error information.

FIG. 17 is a table showing a case of continuing the film camera mode and a case of finishing the film camera mode based on first and second attributes.

FIG. 18 is a descriptive diagram illustrating a case of finishing the film camera mode because of insertion of another memory card.

FIG. 19 is a descriptive diagram illustrating a case of finishing the film camera mode because of duplication or the like of a file or the like in a memory card.

FIGS. 20A and 20B are descriptive diagrams illustrating a case of continuing the film camera mode in a case where the imaging apparatus is powered on again, and FIG. 20C is a descriptive diagram illustrating a case of finishing the film camera mode in a case where a reboot is performed.

FIG. 21 is a descriptive diagram illustrating an initialization method.

FIG. 22 is a table showing a case of executing the film camera mode and a case of finishing the film camera mode based on the first and second attributes.

FIG. 23 is a flowchart illustrating a series of flows of the film camera mode.

### DESCRIPTION OF THE PREFERRED EMBODIMENTS

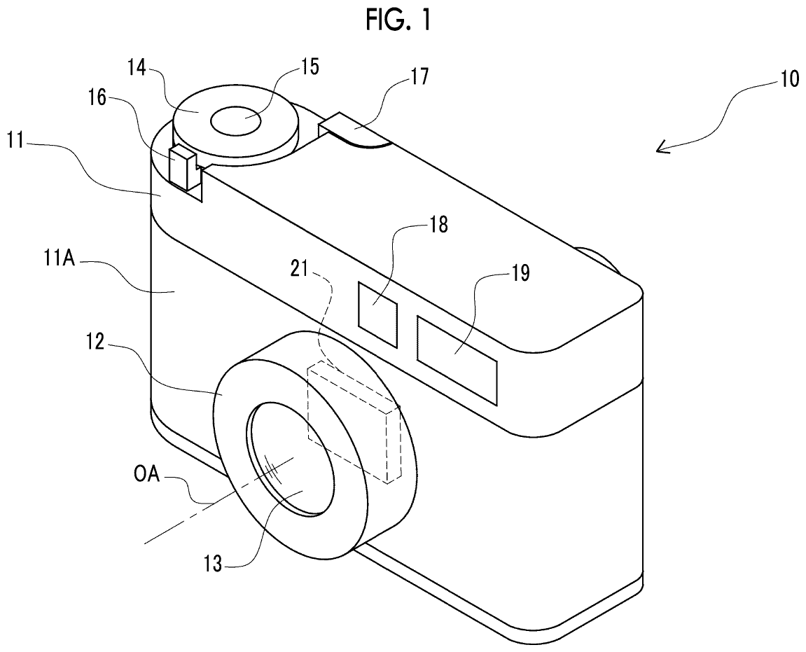

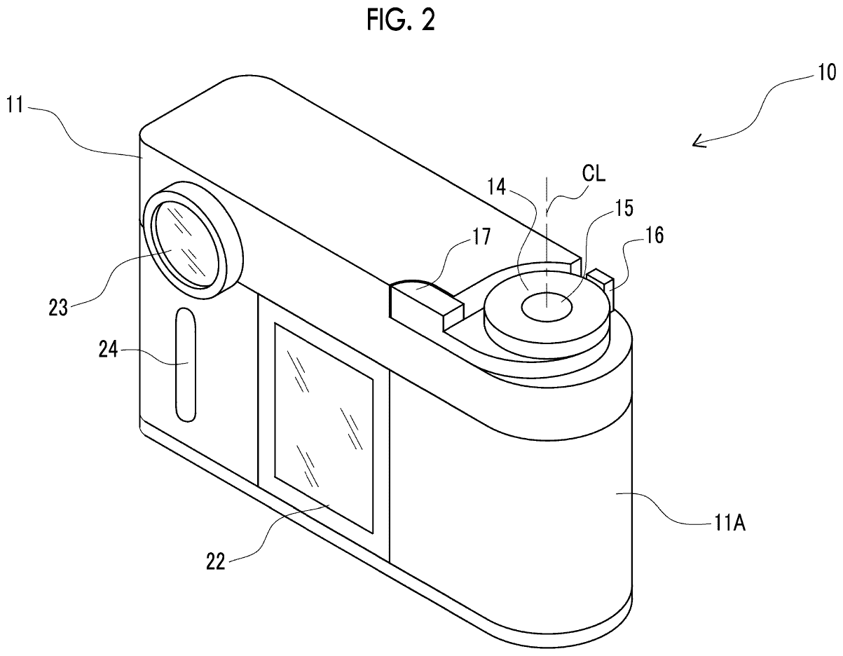

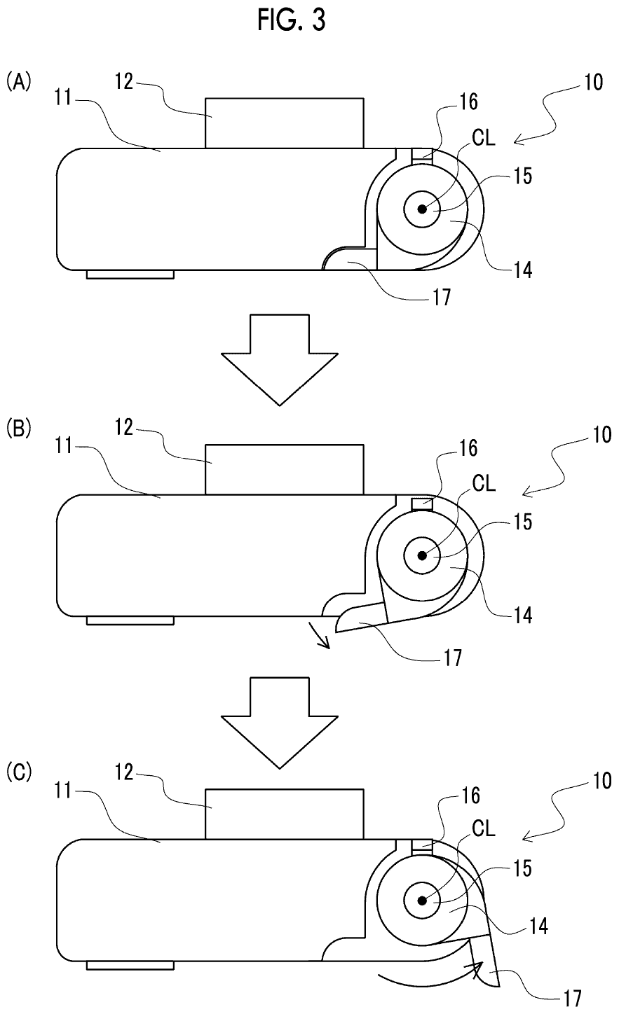

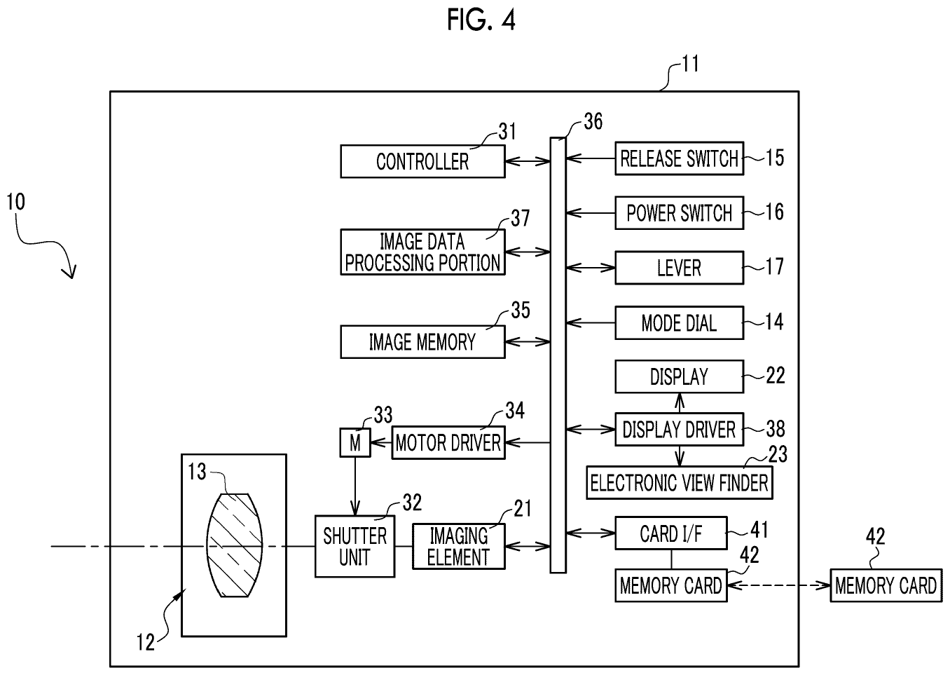

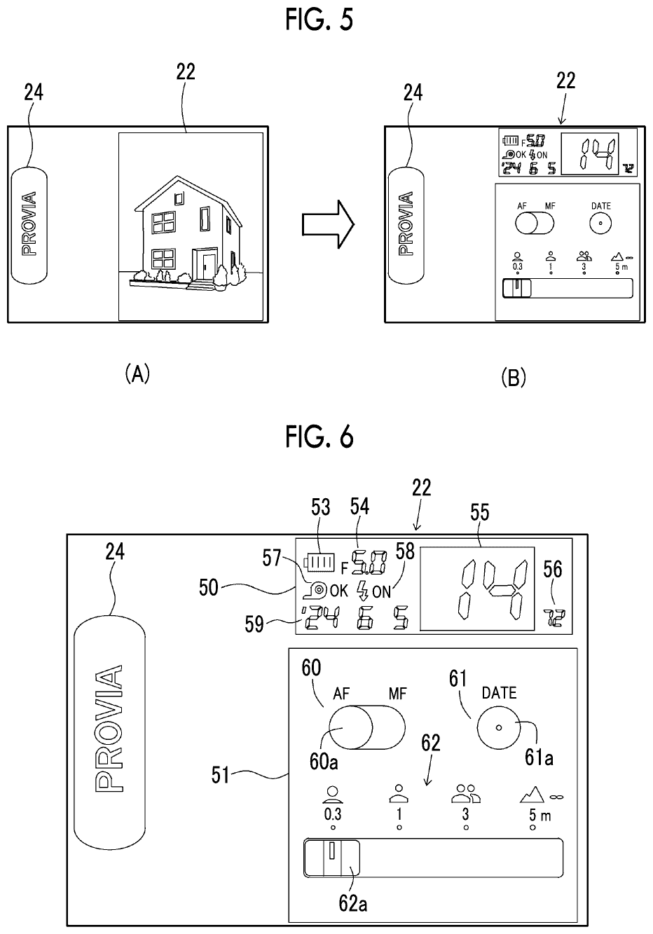

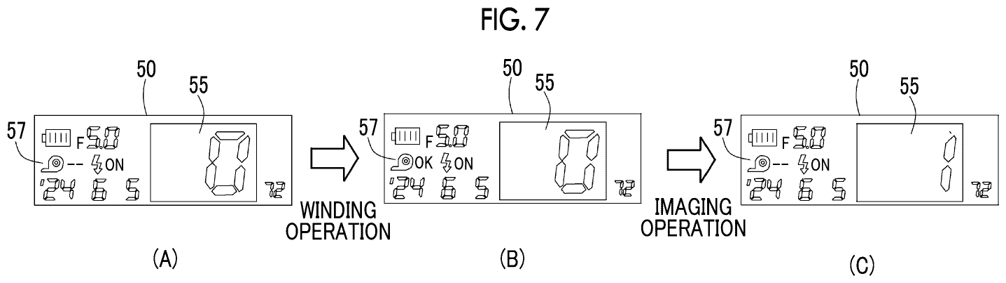

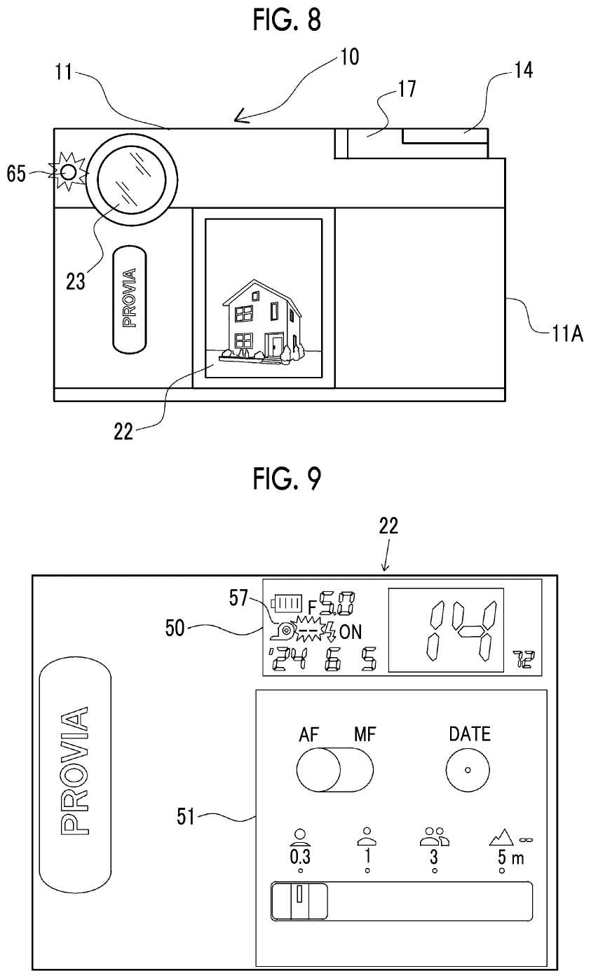

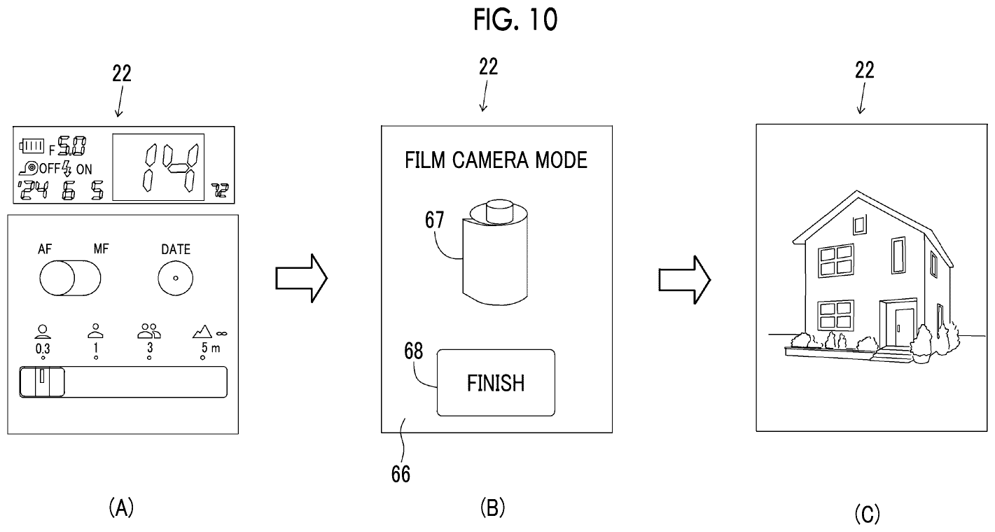

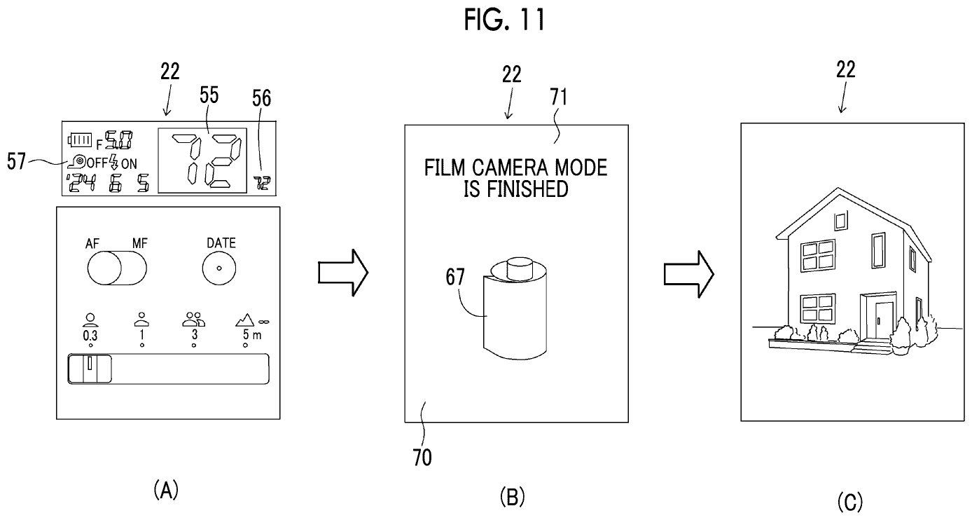

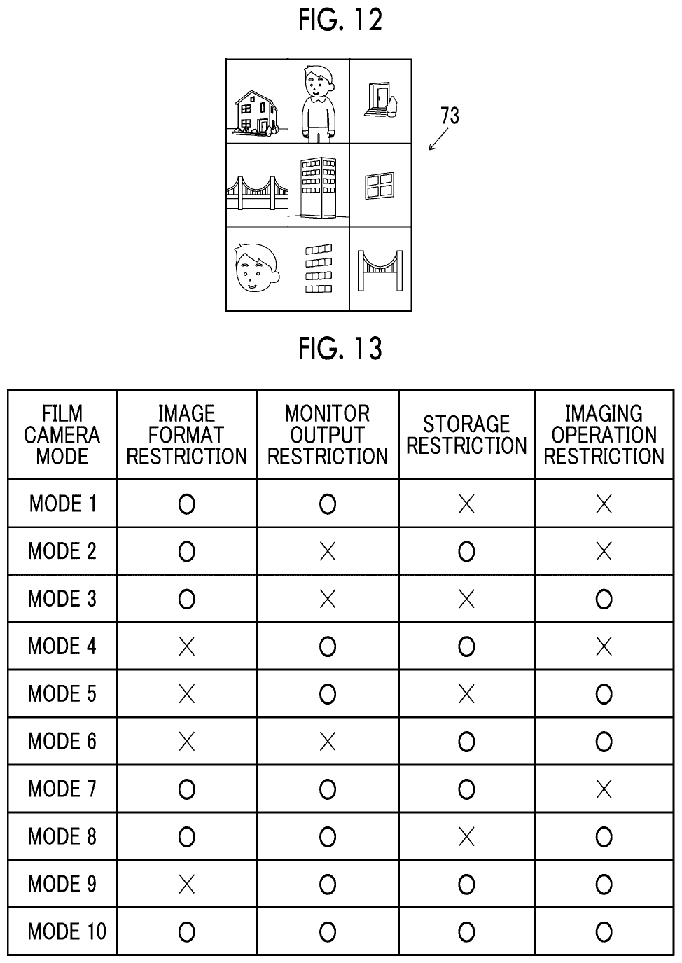

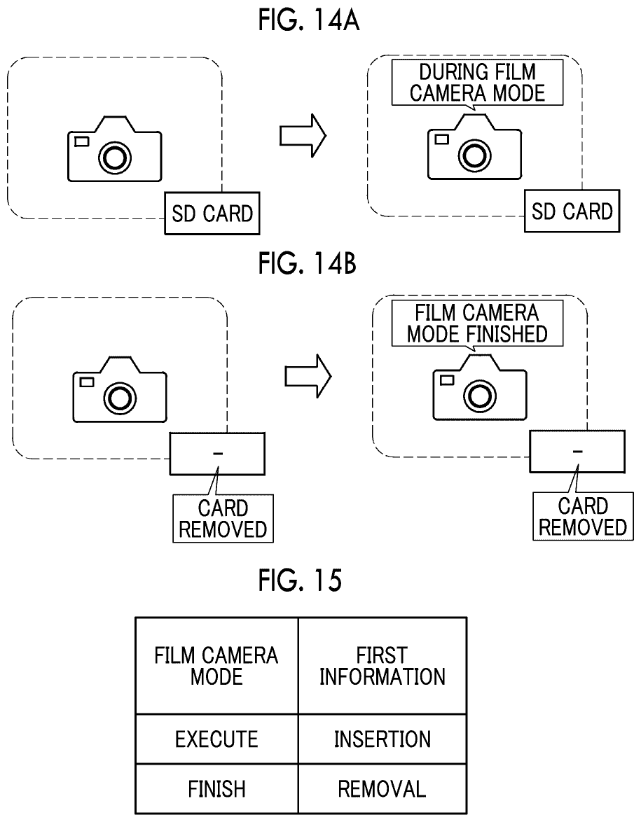

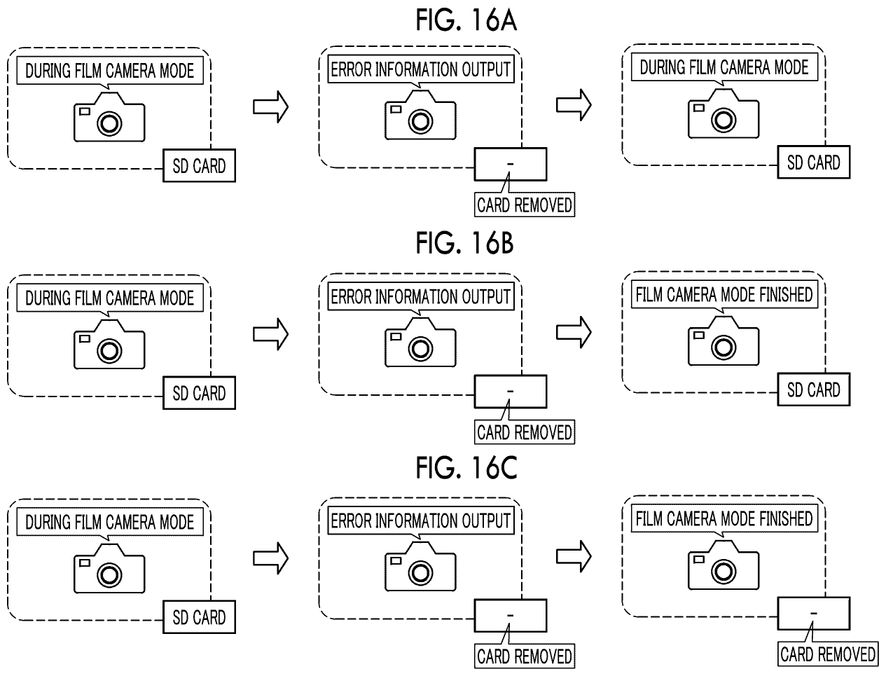

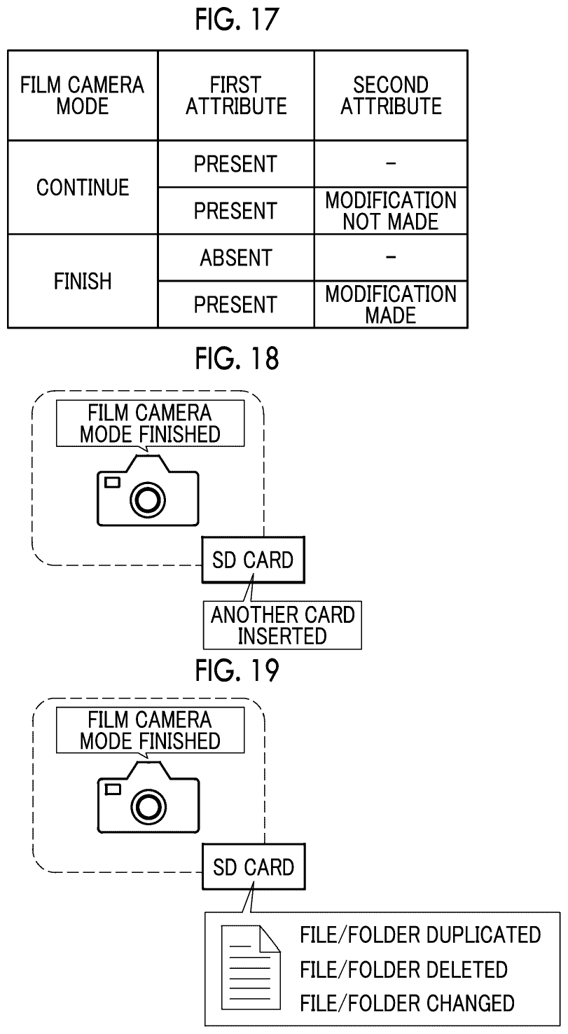

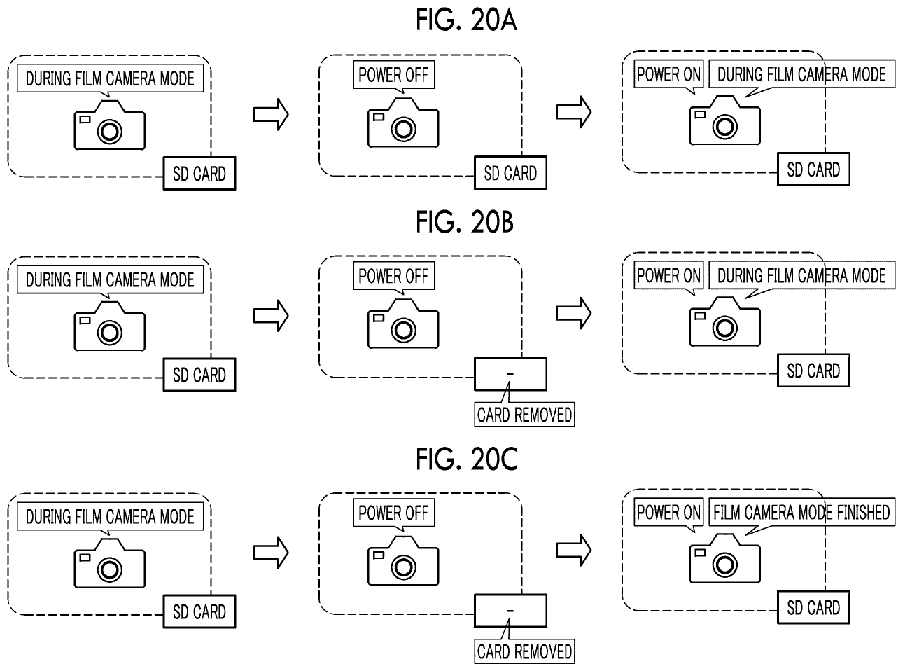

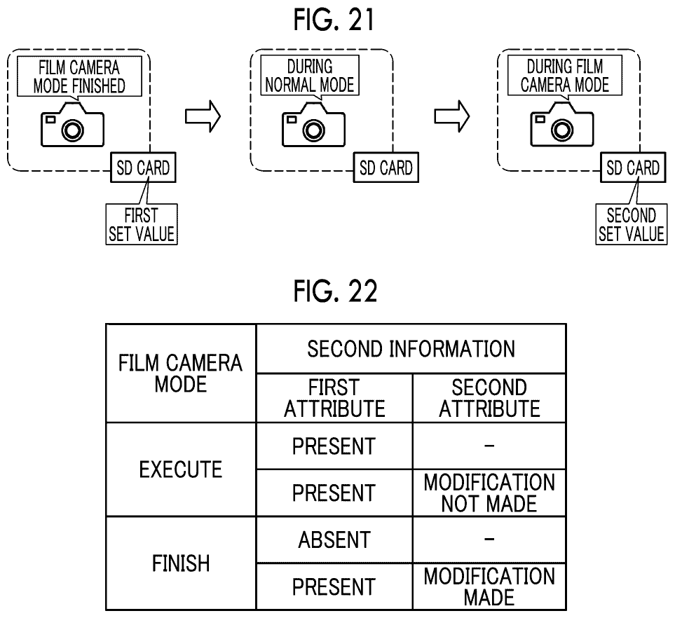

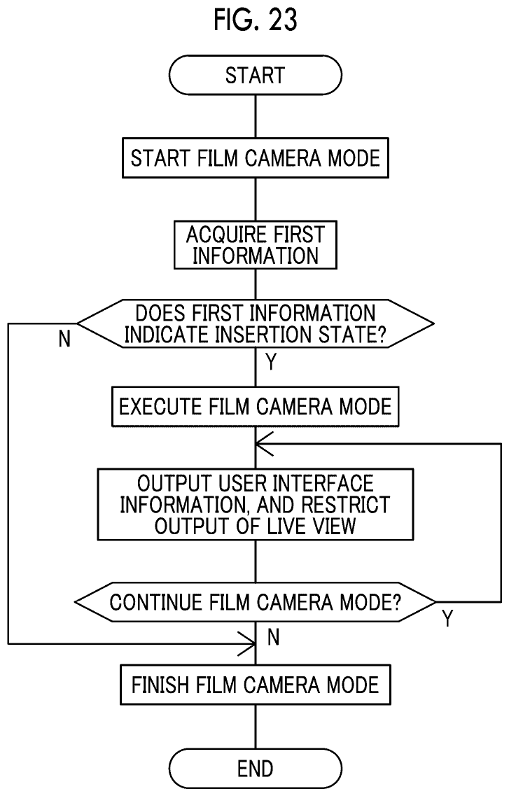

As illustrated in FIG. 1, an imaging apparatus 10 comprises a camera body 11 and a lens barrel 12. The camera body 11 has a horizontally elongated box shape of which a dimension in a left-to-right direction is larger than a dimension in an up-to-down direction in a front view. The imaging apparatus 10 is preferably a digital camera or the like.

The camera body 11 is provided with a grip 11A in its end part on a left side in the front view. The grip 11A has a semi-cylindrical shape connecting a front surface and a rear surface of the camera body 11 and has a shape easily held by a user. The lens barrel 12 is disposed on the front surface of the camera body 11 and is provided with an imaging optical system 13. The imaging optical system 13 forms an image of subject light on an imaging element 21 provided on an optical axis OA.

A mode dial 14, a release switch 15, a power switch 16, a lever 17, and the like are provided on an upper surface of the camera body 11. The mode dial 14 is used for switching an exposure level and the like in a stepwise manner. Not only the lens barrel 12 but also a flash device 18 and an illumination device 19 are provided on the front surface of the camera body 11. The flash device 18 irradiates a subject with illumination light in a case where an exposure value of the subject is less than a certain value, or in a forced manner in line with a shutter release in a case where the imaging apparatus 10 is in a still image capturing mode. Meanwhile, the illumination device 19 constantly irradiates the subject with the illumination light in a case where the imaging apparatus 10 is in a video capturing mode.

As illustrated in FIG. 2, the lever 17 is provided above the grip 11A. The lever 17 is provided by stacking the mode dial 14 and the release switch 15. The lever 17 is attached to be rotatable about a central axis CL of the mode dial 14. The user can perform a rotation operation on the lever 17, and details of the rotation operation will be described later.

The power switch 16 is a push-type switch and is disposed near the mode dial 14 and the lever 17. A power on/off state of the imaging apparatus 10 is alternately switched in response to pushing of the power switch 16.

The camera body 11 incorporates the imaging element 21 (see FIG. 3). The imaging element 21 is held by a holder (not illustrated) and is fixed to the lens barrel 12 on an image plane side. The imaging element 21 has a still image and video capturing function and is, for example, a complementary metal oxide semiconductor (CMOS) image sensor, a charge coupled device (CCD) image sensor, or an organic thin film imaging element. The imaging element 21 is an imaging element of which a length in a vertical direction is smaller than a length in a horizontal direction in a case where the imaging element is laterally placed, that is, the upper surface of the camera body 11 faces upward in the vertical direction. The imaging element 21 is not limited to this and may be an imaging element of which a length in the vertical direction is larger than a length in the horizontal direction in a case where the imaging element is laterally placed, that is, the upper surface of the camera body 11 faces upward in the vertical direction.

A display 22 (a monitor portion), an electronic view finder 23, and a sub-display 24 are provided on the rear surface of the camera body 11. The display 22 is a liquid crystal display (LCD), an organic electroluminescent display (OELD), or the like and is composed of a touch screen on which the user can perform a touch operation. The display 22 is used for live view display, recorded image display, setting menu display, and the like. In the live view display, a recorded image obtained by imaging the subject via the imaging element 21 is displayed in real time on the display 22.

The sub-display 24 displays information related to quality of the image such as color and is composed of a touch screen on which the user can perform the touch operation, like the display 22. While the display 22 corresponds to a monitor portion in the claims, the monitor portion may include the electronic view finder 23 or the sub-display 24.

The electronic view finder 23 is provided in an upper portion of the camera body 11. The electronic view finder 23 displays a live view and displays the recorded image obtained by the imaging the subject via the imaging element 21 in real time. The electronic view finder 23 can be turned on and off, as necessary, and is switched to the display on the display 22.

Hereinafter, the rotation operation of the lever 17 will be described. As illustrated in (A) of FIG. 3, in a case where the power switch 16 is off, a locking mechanism (not illustrated) restricts rotation of the lever 17, and the lever 17 is locked in a posture along the rear surface of the camera body 11. The posture along the rear surface of the camera body 11 means that the lever 17 is at a position at which the lever 17 does not protrude from the rear surface of the camera body 11 in a state seen from above the camera body 11.

As illustrated in (B) of FIG. 3, in a case where the power switch 16 is switched on from off, restriction of the rotation of the lever 17 is released, and the lever 17 is set to a normal position at which the lever 17 is slightly rotated counterclockwise from the rear surface of the camera body 11. The lever 17 is set to a state of the normal position unless the user operates the lever 17. As illustrated in (C) of FIG. 3, a winding operation of performing a rotation operation of the lever 17 in a counterclockwise direction from the normal position can be performed on the lever 17. This rotation operation is used for unlocking a lock on the imaging operation in a film camera mode (unlocking of the lock on the imaging operation will be described later).

Specifically, in the winding operation of the lever 17, the user moves the lever 17 in the counterclockwise direction by hooking a finger on the lever 17, and the lever 17 is rotated. In a case where the finger hooked on the lever 17 is released when the lever 17 is rotated by a certain rotation angle, the lever 17 biased by a spring or the like automatically rotates clockwise and returns to the normal position. Accordingly, the winding operation is completed.

Hereinafter, an electric configuration of the imaging apparatus 10 will be described. As illustrated in FIG. 4, a controller 31 consists of a microcomputer comprising a CPU, a read only memory (ROM) in which a program and a parameter used by the CPU are stored, a random access memory (RAM) used as a work memory of the CPU, and the like (none illustrated) and functions as a processor that controls each unit of the imaging apparatus 10.

In a case where the rotation operation is performed on the lever 17, a signal for detecting an amount of rotation is transmitted to the controller 31. A mode switching signal from the mode dial 14, a release signal from the release switch 15, and a power on/off signal from the power switch 16 are input into the controller 31.

A shutter unit 32 is, for example, a focal plane shutter and is disposed between the imaging optical system 13 and the imaging element 21. The shutter unit 32 is provided to be capable of shielding an optical path between the imaging optical system 13 and the imaging element 21 and changes between an open state and a closed state. The shutter unit 32 is driven by a shutter motor 33. Driving of the shutter motor 33 is controlled by a motor driver 34.

The shutter unit 32 changes to the open state when live view images and videos are captured. In still image capturing, the shutter unit 32 is changeable to the closed state from the open state in a case where the release switch 15 is not operated, and is changeable to the open state from the closed state in a case where the release switch 15 is operated. The shutter unit 32 operates in the same manner as in video capturing in capturing a preview image in the video capturing mode, and as in the still image capturing in capturing a preview image in the still image capturing mode.

Driving of the imaging element 21 is controlled by the controller 31. The imaging element 21 includes a light-receiving surface composed of a plurality of pixels (not illustrated) arranged in a two-dimensional matrix. Each pixel includes a photoelectric conversion element and generates an imaging signal by photoelectrically converting a subject image formed on the light-receiving surface by the imaging optical system 13.

The imaging element 21 comprises signal processing circuits such as a noise removal circuit, an auto gain controller, and an A/D conversion circuit (none illustrated). The noise removal circuit performs noise removal processing on the imaging signal. The auto gain controller amplifies a level of the imaging signal to an optimal value. The A/D conversion circuit converts the imaging signal into a digital signal and outputs the digital signal to a bus line 36 from the imaging element 21. The output signal of the imaging element 21 is image data (so-called RAW data) including one color signal for each pixel.

An image memory 35 stores the image data of one frame output to the bus line 36. An image data processing portion 37 reads out the image data of one frame from the image memory 35 and performs well-known image processing such as a matrix operation, demosaicing, Y correction, brightness and color difference conversion, and resizing processing.

A display driver 38 sequentially inputs the image data of one frame on which the image processing is performed by the image data processing portion 37, into the display 22 or the electronic view finder 23. For example, the display 22 sequentially displays the live view image in a certain period. The touch operation can be performed on the display 22. By performing the touch operation on an operation icon (not illustrated) or the like displayed on the display 22, an operation and selection corresponding to the operation icon are executed.

A card interface (I/F) 41 is incorporated in a card slot (not illustrated) provided in the camera body 11 and is electrically connected to a memory card 42 inserted into the card slot. The memory card 42 can be inserted into and removed from the card slot by the user. Specifically, the card I/F 41 stores the image data on which the image processing is performed by the image data processing portion 37, in the memory card 42. In reproducing and displaying the image data stored in the memory card 42, the card I/F 41 reads out the image data from the memory card 42. An image recording portion is not limited to a configuration of performing recording on a recording medium such as a memory card and may be a storage device such as a solid state drive (SSD).

The imaging apparatus 10 comprises a plurality of imaging modes such as a normal mode (a second imaging mode) and the film camera mode (a first imaging mode). The normal mode includes the still image capturing mode, the video capturing mode, and the like. The film camera mode is a mode in which image formats are restricted, and is a mode in which an analog feel of a film camera is experienced and reproduced. For switching to the film camera mode from the normal mode, as illustrated in FIG. 5, the display 22 is switched to a screen of the film camera mode illustrated in (B) of FIG. 5 from a screen of the normal mode illustrated in (A) of FIG. 5 by performing the touch operation on the sub-display 24. For switching to the normal mode from the film camera mode, switching to the normal mode from the film camera mode is performed in a case where, for example, a selection is made to finish the film camera mode, or a captured image count reaches a predetermined number in the film camera mode.

In a case where the film camera mode is selected, the controller 31 outputs user interface information related to the imaging to the display 22, and output of the live view to the display 22 is restricted. Specifically, as illustrated in FIG. 6, a display region of the display 22 displays a touch operation disabled region 50 in which the user cannot perform the touch operation, such as the captured image count as the user interface information related to the imaging, and a touch operation enabled region 51 in which the user can perform the touch operation, such as manual focus. Restriction of the output of the live view to the display 22 includes not displaying the live view image on the display 22 during the film camera mode, unlike in the normal mode. In the film camera mode, it is preferable to restrict and not display videos among the image formats on the display 22.

Here, “PROVIA” displayed on the sub-display 24 is one type of film simulation that is function enabling color development and contrast to be changed as in the case of switching a film of a camera in accordance with what is intended to be imaged. Switching to a type of film simulation (for example, “VELVIA”) other than “PROVIA” can be performed by performing the touch operation on the sub-display 24.

The touch operation disabled region 50 displays a remaining battery capacity display portion 53, an F number display portion 54, a captured image count display portion 55, a remaining capture count display portion 56, a lever state display portion 57, a flash presence or absence display portion 58, and a date display portion 59. The remaining battery capacity display portion 53 displays a remaining battery capacity with vertical lines in a shape representing a battery. More vertical lines mean more remaining battery capacity. The F number display portion 54 displays an F number as a numerical value. The captured image count display portion 55 displays the current captured image count. The remaining capture count display portion 56 displays a remaining capture count that is a predetermined captured image count at the start of the film camera mode. For example, the remaining capture count is preferably set to 72, 36, or 24 in accordance with the remaining capture count of the camera film.

The lever state display portion 57 displays whether or not the winding operation of the lever 17 is performed in the film camera mode. Details of the lever state display portion 57 will be described later. The flash presence or absence display portion 58 displays ON in a case where the flash device 18 is turned ON, and displays OFF in a case where the flash device 18 is turned off. The date display portion 59 displays the current date, and the date being displayed is displayed in a superimposed manner on the image in the film camera mode.

The touch operation enabled region 51 displays an AF/MF switching portion 60, a date ON/OFF switching portion 61, and an MF focal length operator 62. In the AF/MF switching portion 60, a round button portion 60a can be slid in the left-to-right direction. In a case where the round button portion 60a is slid to the left side, switching to auto focus (AF) is performed. In a case where the round button portion 60a is slid to a right side, switching to the manual focus (MF) is performed. The MF focal length operator 62 can be operated by switching to the MF.

In the date ON/OFF switching portion 61, a push operation can be performed on a round button portion 61a, and switching between date ON and date OFF can be performed by performing the push operation on the round button portion 61a. In the case of date ON, a center portion of the round button portion 61a is illuminated, and the date being displayed in the date display portion 59 is displayed in a superimposed manner for each imaging. Meanwhile, in the case of date OFF, the center portion of the round button portion 61a is not illuminated. In this case, the date is not displayed in a superimposed manner even in a case where the imaging is performed.

The MF focal length operator 62 includes a slider 62a, and a focal length is set by performing a sliding operation of the slider 62a in the left-to-right direction. In the MF focal length operator 62, the focal length can be set to “0.3 m”, “1 m”, “3 m”, or “5 m”. In the case of “0.3 m”, a logo representing an example of focusing on near a face of one person is displayed. In the case of “1 m”, a logo representing an example of focusing on an upper body of one person is displayed. In the case of “3 m”, a logo representing an example of focusing on upper bodies of two persons is displayed. In the case of “5 m”, a logo representing an example of focusing on a landscape is displayed. By setting the slider 62a to each position of “0.3 m”, “1 m”, “3 m”, and “5 m”, the corresponding focal length can be set.

The controller 31 sets a lock on the imaging operation of the release switch 15 (a first member) in the film camera mode and unlocks the lock based on an operation of the lever 17 (a second member). Meanwhile, in a case where the lock is unlocked, the controller 31 outputs information indicating that the imaging operation of the release switch 15 is valid, as the user interface information. In a case where the imaging operation of the release switch 15 is performed, the controller 31 outputs information related to the captured image count as the user interface information. The controller 31 restricts output of the image data of the imaging to the display 22.

Specifically, as illustrated in (A) of FIG. 7, in a case where switching to the film camera mode from the normal mode is performed, the lever state display portion 57 displays “--” indicating that the winding operation of the lever 17 is not performed. The captured image count display portion 55 displays the current captured image count as “O”. In this state, the lock is set on the imaging operation of the release switch 15, and acquisition and storage of a still image in the memory card 42 are not performed even in a case where the release switch 15 is operated.

As illustrated in (B) of FIG. 7, by performing the winding operation of the lever 17, the lever state display portion 57 displays “OK” indicating that the winding operation of the lever 17 is performed. The display of “OK” in the lever state display portion 57 represents information indicating that the imaging operation of the release switch 15 is valid. In this state, the lock on the imaging operation of the release switch 15 is unlocked, and acquisition and storage of the still image in the memory card 42 are performed by operating the release switch 15. In a case where the imaging operation is completed, as illustrated in (C) of FIG. 7, the captured image count display portion 55 changes the display of the current captured image count to “1” from “0”, and the lever state display portion 57 is restored to the display of “--” again by resetting the winding operation. When the imaging operation is completed, the display 22 maintains the display of the user interface information (the touch operation disabled region and the touch operation enabled region) of the film camera mode and does not display the image data after the imaging.

In a case where the imaging operation is performed while the lock is set on the imaging operation, the controller 31 preferably outputs information indicating that the imaging operation is invalid. Specifically, as illustrated in FIG. 8, it is preferable to turn on and off a warning light emitting diode (LED) 65 provided on the left side of the electronic view finder 23, as the information indicating that the imaging operation is invalid. As illustrated in FIG. 9, it is preferable to flash on and off “--” in the lever state display portion 57, as the information indicating that the imaging operation is invalid.

In a case where a selection to finish the film camera mode is made, the controller 31 preferably stores a series of the image data obtained by the imaging in the memory card 42 (a recording medium) in a single unit format. In a case where the film camera mode is finished, the controller 31 transitions to the normal mode in which the restriction of the output to the display 22 is released.

Specifically, as illustrated in (A) of FIG. 10, in the case of finishing the film camera mode in the middle of the film camera mode, a predetermined touch operation for switching the film camera mode to a finish screen is performed on the sub-display 24. Accordingly, as illustrated in (B) of FIG. 10, a film camera mode finish selection screen 66 is displayed on the display 22. The film camera mode finish selection screen 66 displays a cartridge image 67 representing that the series of the image data obtained by the imaging will be stored in a single unit format, and a finish selection button 68. The film camera mode is finished by performing the touch operation on the finish selection button 68, and the series of the image data obtained by the imaging are stored in the memory card 42 in a single unit format. Accordingly, as illustrated in (C) of FIG. 10, a transition is made to the normal mode. The non-display of the live view on the display 22 is released, and the live view is displayed on the display 22.

In the film camera mode, in a case where the captured image count reaches the predetermined number, the controller 31 preferably invalidates the imaging operation of the release switch 15 and unlocking of the lock on the imaging operation of the lever 17. In the film camera mode, in a case where the captured image count reaches the predetermined number, the controller 31 preferably stores the series of the image data obtained by the imaging in the memory card 42 in a single unit format. In a case where the film camera mode is finished, the controller 31 transitions to the normal mode in which the restriction of the output to the display 22 is released.

Specifically, as illustrated in (A) of FIG. 11, in a case where the captured image count reaches “72” that is the remaining capture count, the lever state display portion 57 displays “OFF” indicating that the imaging operation based on the winding operation of the lever 17 is invalid. Accordingly, the imaging operation of the release switch 15 is also invalidated. After a certain amount of time, the display 22 displays a film camera mode finish screen 70, as illustrated in (B) of FIG. 11. The film camera mode finish screen 70 displays the cartridge image 67 representing that the series of the image data obtained by the imaging will be stored in a single unit format, and a message 71 indicating that the film camera mode is finished. Accordingly, the film camera mode is finished, and the series of the image data obtained by the imaging are stored in the memory card 42 in a single unit format. By performing a tap operation on the display 22, a transition is made to the normal mode, as illustrated in (C) of FIG. 11. The non-display of the live view on the display 22 is released, and the live view is displayed on the display 22.

In the film camera mode, the series of the image data obtained by the imaging are preferably stored in the memory card 42 in a single unit format on which display restriction on the display 22 is imposed. For example, as illustrated in FIG. 12, the series of the image data are stored in the memory card 42 as a thumbnail image group 73 representing each piece of the image data of the captured image count captured so far as a thumbnail. During the film camera mode, since the display restriction on the display 22 is imposed on the thumbnail image group 73, the thumbnail image group 73 is not displayed on the display 22 even in a case where a play button (not illustrated) is operated. Meanwhile, in a case where the film camera mode is finished, the display restriction on the thumbnail image group 73 is released, and the thumbnail image group 73 can be displayed on the display 22.

The film camera mode is preferably a mode in which a digital function of the imaging apparatus 10 is restricted. The controller 31 preferably performs at least two of restriction of the image format, restriction of the output of the live view to the display 22, restriction of the storage of the series of the image data obtained by the imaging in the film camera mode in a format other than the format of a single unit, restriction of the captured image count, and restriction of a second imaging operation following a first imaging operation, as the restriction of the digital function.

Specifically, the restriction of the image format preferably allows still images and restricts videos. For the restriction of the output of the live view to the display 22, it is preferable not to display the live view on the display 22. For the restriction of the storage of the series of the image data obtained by the imaging in the film camera mode in a format other than the format of a single unit, it is preferable to prohibit storage in a format other than the thumbnail image group 73. For the restriction of the captured image count, it is preferable to prohibit capturing of the captured image count exceeding the remaining capture count set at the start of the film camera mode. For the restriction of the second imaging operation following the first imaging operation, it is preferable to prohibit consecutive imaging operations of the release switch 15 with respect to the imaging operation of the release switch 15 and, after the first imaging operation is performed, allow the second imaging operation after unlocking the lock on the imaging operation by performing the winding operation of the lever 17.

For the film camera mode, ten patterns of mode 1 to mode 10 can be set as illustrated in FIG. 13. In mode 1 of the film camera mode, two types of restriction including the restriction of the image format (image format restriction) and the restriction of the output of the live view to the display 22 (monitor output restriction) are performed. In mode 2 of the film camera mode, two types of restriction including the image format restriction and the restriction of the storage of the series of the image data obtained by the imaging in the film camera mode in a format other than the format of a single unit (storage restriction) are performed. In mode 3 of the film camera mode, it is preferable to perform two types of restriction including the image format restriction and the restriction of the second imaging operation following the first imaging operation (imaging operation restriction).

In mode 4 of the film camera mode, it is preferable to perform two types of restriction including the monitor output restriction and the storage restriction. In mode 5 of the film camera mode, it is preferable to perform two types of restriction including the monitor output restriction and the imaging operation restriction. In mode 6 of the film camera mode, it is preferable to perform two types of restriction including the storage restriction and the imaging operation restriction. In mode 7 of the film camera mode, it is preferable to perform three types of restriction including the image format restriction, the monitor output restriction, and the storage restriction. In mode 8 of the film camera mode, it is preferable to perform three types of restriction including the image format restriction, the monitor output restriction, and the imaging operation restriction. In mode 9 of the film camera mode, it is preferable to perform three types of restriction including the monitor output restriction, the storage restriction, and the imaging operation restriction. In mode 10 of the film camera mode, it is preferable to perform four types of restriction including the image format restriction, the monitor output restriction, the storage restriction, and the imaging operation restriction.

The controller 31 controls execution, continuation, and finish of the film camera mode (the first imaging mode). The controller 31 acquires first information related to insertion and removal of the memory card 42 (the recording medium) in which the imaging data of the imaging apparatus 10 is recorded, and restricts the film camera mode related to the function of the imaging apparatus 10 based on the first information. The first information is preferably information including a state of insertion and removal of the memory card 42. While the restriction of the film camera mode is the finish of the film camera mode in the present embodiment, the restriction of the film camera mode also includes a case of pausing only a part of the functions of the film camera mode and executing the rest.

Specifically, in a case where the film camera mode is started, the controller 31 preferably performs a first control that is control of any of executing the film camera mode or restricting the film camera mode, based on the first information. The film camera mode is started by performing the touch operation on the sub-display 24, as described above. As illustrated in FIG. 14A, the controller 31 executes the film camera mode in a case where the first information indicates an insertion state of the memory card 42 (see FIG. 15). Meanwhile, as illustrated in FIG. 14B, the film camera mode is finished in a case where the first information indicates a removal state of the memory card 42 (see FIG. 15). The start of the film camera mode includes not only a case of selecting the film camera mode in the already started imaging apparatus 10 but also a case of setting the film camera mode when the imaging apparatus 10 is started.

Here, in FIGS. 14A and 14B, a state where a rectangular solid line box includes “SD card” represents the insertion state of the memory card 42, and a state where a rectangular solid line box includes “-” represents the removal state of the memory card 42. A figure of a camera represents the imaging apparatus 10. The insertion state or the removal state and the representation of the camera are the same in other drawings. While examples of the memory card 42 include an SD card in the present embodiment, other recording media (such as a USB memory) may be used.

Next, in a case where the film camera mode is executed, the controller 31 preferably outputs error information based on the first information. For example, the error information may be displayed on the display 22 or may be provided by voice or the like. After the error information is output, the controller 31 preferably performs a second control that is a control of any of continuing the film camera mode or restricting the film camera mode, based on the first information.

Specifically, as illustrated in each of FIGS. 16A, 16B, and 16C, in a case where the first information is changed to the removal state from the insertion state during the film camera mode, the imaging apparatus 10 outputs the error information. After the error information is output, as illustrated in FIGS. 16A and 16B, in a case where the first information is changed to the insertion state by inserting the memory card 42, a control of any of continuing the film camera mode or finishing the film camera mode is performed. Meanwhile, as illustrated in FIG. 16C, in a case where the memory card 42 is not inserted and the first information is maintained as the removal state even after an elapse of a certain amount of time, a control of finishing the film camera mode is performed.

As the control performed after the error information is output, in a case where the first information is changed to the insertion state, the controller 31 preferably determines the presence or absence of a first attribute assigned to the memory card 42 by executing the film camera mode. As illustrated in FIG. 17, in a case where the first attribute is present, the film camera mode is continued (see FIG. 16A). In a case where the first attribute is absent, the film camera mode is finished (see FIG. 16B). For example, a case where the first attribute is absent is a case where the memory card 42 that is inserted again is a card different from the memory card 42 before insertion, as illustrated in FIG. 18.

The first attribute is created in the memory card 42 at the first start of the film camera mode as a management file. The management file includes not only the first attribute but also a second attribute (described later). The management file preferably includes a start date and time and a finish date and time of the film camera mode, the remaining capture count at the start of the film camera mode, a memory card capacity at the start of the film camera mode, a film simulation/filter setting during the film camera mode, and the like.

As the control performed after the error information is output, in a case where the first information is changed to the insertion state, the controller 31 preferably determines the presence or absence of the first attribute. As illustrated in FIG. 17, in a case where the first attribute is present and an external change is not made to the second attribute assigned to data of the memory card 42 in association with a history record (a modification is not made), the film camera mode is continued (see FIG. 16A). Meanwhile, in a case where the first attribute is present and an external change is made to the second attribute (a modification is made), the film camera mode is finished (see FIG. 16B). For example, a case where an external change is made to the second attribute means that duplication, deletion, change, or the like of a file/folder is performed in the memory card 42, as illustrated in FIG. 19.

As a method of determining whether or not an external change is made, for example, in a case where a capacity obtained by subtracting an image data capacity of the captured image count captured so far from the memory card capacity at the start of the film camera mode, which is one type of the second attribute, falls within a predetermined range as a card capacity of the memory card 42 after being inserted again, it is preferable to determine that a modification is not made. In a case where the capacity does not fall within the predetermined range, it is preferable to determine that a modification is made.

Examples of continuing the film camera mode after the error information is output include
a case where the memory card 42 that is removed is inserted without manipulating the data and the like, and
a case where the memory card 42 in which a part of image files other than those in the current film camera mode is deleted is inserted.

Meanwhile, examples of finishing the film camera mode after the error information is output include
a case where the memory card 42 in which a part of image files being captured in the current film camera mode is deleted is inserted,
a case where another memory card 42 of which only an overall folder configuration is the same as that of the memory card 42 is inserted,
a case where the memory card 42 in which some files are written is inserted,
a case where the memory card 42 in which the management file is deleted is inserted,
a case where the memory card 42 in which all image files are deleted is inserted,
a case where another memory card 42 is inserted,
a case where a cloned memory card 42 is inserted,
a case where the same memory card 42 is set to be protected and inserted,
a case where the memory card 42 used in another imaging apparatus is inserted (a case where the memory card capacity is smaller than that during the imaging), and
a case where the memory card 42 is replaced with the memory card 42 being used in the film camera mode in another imaging apparatus.

In a case where the film camera mode is executed, and the imaging apparatus 10 is powered off and then, powered on again, the controller 31 preferably performs a third control that is a control of any of continuing the film camera mode or restricting the film camera mode, based on the first information. Powering on and off of the imaging apparatus 10 includes not only a case of powering the imaging apparatus 10 on and off by operating a power button of the imaging apparatus 10 but also a case of powering the imaging apparatus 10 on and off by inserting and removing the battery inserted in the imaging apparatus 10.

Specifically, as illustrated in each of FIGS. 20A, 20B, and 20C, in a case where the imaging apparatus 10 is powered OFF during the film camera mode, and the same memory card 42 remains inserted and the insertion state is maintained in the first information until the imaging apparatus 10 is powered ON again, as illustrated in FIG. 20A, the film camera mode continues. As illustrated in (B) and FIG. 20C, in a case where the imaging apparatus 10 is powered OFF, the memory card 42 is then removed, and the imaging apparatus 10 is powered ON, and the memory card 42 is inserted and the first information is changed to the removal state from the insertion state, the controller 31 performs a control of any of continuing the film camera mode or restricting the film camera mode.

As the control in a case where the imaging apparatus 10 is powered on again, in a case where the imaging apparatus 10 is powered off and then, powered on again, the controller 31 preferably determines the presence or absence of the first attribute. As illustrated in FIG. 17, in a case where the first attribute is present, the film camera mode is continued (see FIG. 20B). In a case where the first attribute is absent, the film camera mode is finished (see FIG. 20C).

As the control in a case where the imaging apparatus 10 is powered on again, in a case where the imaging apparatus 10 is powered off and then, powered on again, the controller 31 preferably determines the presence or absence of the first attribute. As illustrated in FIG. 17, in a case where the first attribute is present and an external change is not made to the second attribute (a modification is not made), the film camera mode is continued (see FIG. 20B). Meanwhile, in a case where the first attribute is present and an external change is made to the second attribute (a modification is made), the film camera mode is finished (see FIG. 20C).

Examples of continuing the film camera mode in a case where the imaging apparatus 10 is powered OFF during the film camera mode include
a case where the memory card 42 is removed, and then the removed memory card 42 is inserted without manipulating the data and the like and the imaging apparatus 10 is powered ON, and
a case where the memory card 42 is removed, and then the memory card 42 in which a part of image files other than those in the current film camera mode is deleted is inserted and the imaging apparatus 10 is powered ON.

Meanwhile, examples of finishing the film camera mode in a case where the imaging apparatus 10 is powered OFF during the film camera mode and the memory card 42 is removed include
a case where the memory card 42 in which a part of image files being captured in the current film camera mode is deleted is inserted, and the imaging apparatus 10 is powered ON,
a case where another memory card 42 of which only an overall folder configuration is the same as that of the memory card 42 is inserted, and the imaging apparatus 10 is powered ON,
a case where the memory card 42 in which some files are written is inserted, and the imaging apparatus 10 is powered ON,
a case where the memory card 42 in which the management file is deleted is inserted, and the imaging apparatus 10 is powered ON,
a case where the memory card 42 in which all image files are deleted is inserted, and the imaging apparatus 10 is powered ON,
a case where another memory card 42 is inserted, and the imaging apparatus 10 is powered ON,
a case where a cloned memory card 42 is inserted, and the imaging apparatus 10 is powered ON,
a case where the same memory card 42 is set to be protected and inserted, and the imaging apparatus 10 is powered ON,
a case where the imaging apparatus 10 is powered ON without inserting the memory card 42,
a case where the same memory card 42 is inserted after powering the imaging apparatus 10 ON,
a case where the memory card 42 used in another imaging apparatus is inserted, and the imaging apparatus 10 is powered ON (a case where the memory card capacity is smaller than that during the imaging), and
a case where the memory card 42 is replaced with the memory card 42 being used in the film camera mode in another imaging apparatus, and the imaging apparatus 10 is powered ON.

It is also preferable to finish the film camera mode in a case where the battery is removed without powering the imaging apparatus 10 OFF in the film camera mode.

Next, in a case where the film camera mode is finished, the controller 31 preferably performs initialization related to the film camera mode. As illustrated in FIG. 21, the initialization is preferably processing of not using a first set value set in first imaging in the film camera mode as a second set value set in second imaging that is imaging in the subsequent film camera mode. By performing the initialization, the set value used in the previous film camera mode is not carried over (reset) in the subsequent film camera mode. Here, for example, the first set value or the second set value is the remaining capture count, a pattern of the film simulation, the exposure level set using the mode dial 14, and the F number. In a case where the film camera mode is finished, the normal mode is automatically executed (see FIGS. 10 and 11). Thus, a new start operation is necessary to start the subsequent film camera mode.

Execution and finish of the film camera mode may be controlled based on information different from the first information. In a case where the memory card 42 is inserted, the controller 31 may acquire second information related to an attribute of the memory card 42 and restrict the film camera mode based on the second information. Specifically, the attribute preferably includes any of the first attribute assigned to the memory card 42 by executing the film camera mode or the second attribute assigned to the data of the memory card 42 in association with the history record. The first attribute and the second attribute are the same as described above.

As illustrated in FIG. 22, in a case where the first attribute is present with respect to the second information, or in a case where the first attribute is present and the second attribute is not modified with respect to the second information, the film camera mode is executed in a case where the memory card 42 is inserted. Meanwhile, in a case where the first attribute is absent with respect to the second information, or in a case where the first attribute is present and the second attribute is modified with respect to the second information, the film camera mode is finished.

Next, an imaging method according to the embodiment of the present invention will be described with reference to the flowchart in FIG. 23. The film camera mode is started by causing the user to perform the touch operation on the sub-display 24. The film camera mode is an imaging mode in which the image format is restricted. The controller 31 acquires the first information related to insertion and removal of the memory card 42 in which the imaging data of the imaging apparatus 10 is recorded, and performs a step of restricting the film camera mode based on the first information. In the film camera mode restriction step, in a case where the first information indicates the insertion state of the memory card 42, the controller 31 executes the film camera mode. Meanwhile, in a case where the first information indicates the removal state of the memory card 42, the controller 31 finishes the film camera mode.

In a case where the film camera mode is executed (selected), a step of outputting the user interface information related to the imaging to the display 22 and restricting the output of the live view to the display 22 is performed. The display of the user interface information and the restriction of the output of the live view continue during the film camera mode. In a case where the film camera mode is finished, switching to the normal mode from the film camera mode is performed. By switching to the normal mode, the live view is displayed on the display 22.

An imaging program according to the embodiment of the present invention is a program causing the controller 31 to execute a process including acquiring the first information related to insertion and removal of the memory card 42 in which the imaging data of the imaging apparatus 10 is recorded, and restricting the film camera mode based on the first information. It is preferable that the imaging program according to the embodiment of the present invention is installed on the imaging apparatus 10 at the time of manufacturing or the like of the imaging apparatus 10 or is installed on the imaging apparatus 10 through a network or the like after the imaging apparatus 10 is shipped.

In the present embodiment, each processing is executed by any computer. Any computer may execute those processing via a processor, a program, or a combination thereof. Any computer may be a general-purpose computer, a computer for a specific purpose, a system such as a workstation, or other hardware elements capable of executing a program.

The processor may be composed of one or a plurality of pieces of hardware, and types of hardware are not limited. For example, the processor may be composed of hardware such as a central processing unit (CPU), a micro processing unit (MPU), a programmable logic device such as a field programmable gate array (FPGA), a dedicated circuit for executing specific processing, such as an application specific integrated circuit (ASIC), a graphic processing unit (GPU), or a neural processing unit (NPU). The processor includes each unit or each means that executes various types of processing in the present embodiment. Types of hardware may be a combination of different types of hardware. In a case where a plurality of pieces of hardware are configured to execute one or a plurality of types of processing of a processor, the plurality of pieces of hardware may be present in apparatuses physically separated from each other or may be present in the same apparatus. In any embodiment, the order of each processing via the processor is not limited to the above order and may be appropriately changed. The hardware is composed of an electric circuit (circuitry) in which circuit elements such as semiconductor elements are combined.

The present embodiment may be implemented by hardware, software, firmware, microcode, or a combination thereof. Software, firmware, and microcode are composed of a program. For example, the program may be a program module group, and each function thereof may be implemented by a processor configured to execute each function. The program may be a program code or a plurality of code segments stored in one or a plurality of non-transitory computer-readable media (for example, storage media or other storages). The program may be divided and stored in a plurality of non-transitory computer-readable media present in apparatuses physically separated from each other. The program code or the code segments may represent any combination of a procedure, a function, a subprogram, a routine, a subroutine, a module, a software package, a class, an instruction, a data structure, and a program statement. The program code or the code segments may be connected to other code segments or hardware circuits by transmitting and receiving information, data, an argument, a parameter, or content of a memory.

While each embodiment illustrates the digital camera in which the imaging optical system 13 is fixed to the camera body 11, the present invention is not limited to this, and a lens-interchangeable digital camera in which an imaging optical system is interchangeable with respect to a camera body may be applied. While each embodiment illustrates the lens barrel 12 not including a zoom lens, the present invention is not limited to this, and the imaging optical system 13 may be configured to include a zoom lens. The present invention can be applied to a smartphone and a camera such as a video camera, other than the digital camera.

### EXPLANATION OF REFERENCES

10: imaging apparatus
11: camera body
11A: grip
12: lens barrel
13: imaging optical system
14: mode dial
15: release switch
16: power switch
17: lever
18: flash device
19: illumination device
21: imaging element
22: display
23: electronic view finder
24: sub-display
31: controller
32: shutter unit
33: shutter motor
34: motor driver
35: image memory
36: bus line
37: image data processing portion
38: display driver
41: card interface (I/F)
42: memory card
50: touch operation disabled region
51: touch operation enabled region
53: remaining battery capacity display portion
54: F number display portion
55: captured image count display portion
56: remaining capture count display portion
57: lever state display portion
58: flash presence or absence display portion
59: date display portion
60: AF/MF switching portion
60a: round button portion
61: date ON/OFF switching portion
61a: round button portion
62: MF focal length operator
62a: slider
65: warning LED
66: film camera mode finish selection screen
67: cartridge image
68: finish selection button
70: film camera mode finish screen
71: message
73: thumbnail image group
CL: central axis
OA: optical axis

What is claimed is:

1. An imaging apparatus comprising:
a processor,
wherein the processor is configured to:
acquire first information related to insertion or removal of a recording medium on which imaging data of the imaging apparatus is recorded; and
restrict a first imaging mode related to a function of the imaging apparatus based on the first information.

2. The imaging apparatus according to claim 1,
wherein, in a case where the first imaging mode is started,
the processor is configured to perform a first control of either executing or restricting the first imaging mode, based on the first information.

3. The imaging apparatus according to claim 1,
wherein, in a case where the first imaging mode is executed,
the processor is configured to output error information based on the first information.

4. The imaging apparatus according to claim 3,
wherein, after the error information is output,
the processor is configured to perform a second control of either continuing or restricting the first imaging mode, based on the first information.

5. The imaging apparatus according to claim 1,
wherein, in a case where the first imaging mode is executed, and the imaging apparatus is powered off and then, powered on again,
the processor is configured to perform a third control of either continuing or restricting the first imaging mode, based on the first information.

6. The imaging apparatus according to claim 1,
wherein, in a case where the first imaging mode is finished,
the processor is configured to perform initialization related to the first imaging mode.

7. The imaging apparatus according to claim 6,
wherein the initialization includes processing that prevents a first set value, set in first imaging in the first imaging mode, from being reused as a second set value in second imaging in the subsequent first imaging mode.

8. The imaging apparatus according to claim 1,
wherein, in a case where the first imaging mode is finished,
the processor is configured to execute a second imaging mode different from the first imaging mode.

9. The imaging apparatus according to claim 1,
wherein the first imaging mode is an imaging mode in which a captured image count is restricted.

10. The imaging apparatus according to claim 1,
wherein the first imaging mode is an imaging mode in which image formats are restricted.

11. The imaging apparatus according to claim 1,
wherein the first imaging mode is an imaging mode in which the processor is configured to restrict output of a live view to a monitor portion.

12. The imaging apparatus according to claim 1,
wherein the first imaging mode is an imaging mode in which storage of a series of image data obtained by imaging in the first imaging mode in a format other than a single unit format is restricted.

13. The imaging apparatus according to claim 1,
wherein the first information is information including a state of the insertion or removal of the recording medium.

14. The imaging apparatus according to claim 1,
wherein the processor is configured to:
in a case where the first information indicates an insertion state of the recording medium, execute the first imaging mode; and
in a case where the first information indicates a removal state of the recording medium, restrict the first imaging mode.

15. The imaging apparatus according to claim 1,
wherein the processor is configured to:
determine presence or absence of a first attribute assigned to the recording medium by executing the first imaging mode; and
continue the first imaging mode in a case where the first attribute is present, and restrict the first imaging mode in a case where the first attribute is absent.

16. The imaging apparatus according to claim 1,
wherein the processor is configured to:
determine presence or absence of a first attribute assigned to the recording medium by executing the first imaging mode;
continue the first imaging mode in a case where the first attribute is present and an external change is not made to a second attribute assigned to data of the recording medium in association with a history record; and
restrict the first imaging mode in a case where the first attribute is present and an external change is made to the second attribute assigned to the data of the recording medium in association with the history record.

17. The imaging apparatus according to claim 1,
wherein the processor is configured to:
in a case where the imaging apparatus is powered off and subsequently powered on again, determine presence or absence of a first attribute assigned to the recording medium by executing the first imaging mode; and
continue the first imaging mode in a case where the first attribute is present, and restrict the first imaging mode in a case where the first attribute is absent.

18. The imaging apparatus according to claim 1,
wherein the processor is configured to:
in a case where the imaging apparatus is powered off and subsequently powered on again, determine presence or absence of a first attribute assigned to the recording medium by executing the first imaging mode;
continue the first imaging mode in a case where the first attribute is present and an external change is not made to a second attribute assigned to data of the recording medium in association with a history record; and
restrict the first imaging mode in a case where the first attribute is present and an external change is made to the second attribute assigned to the data of the recording medium in association with the history record.

19. An imaging apparatus comprising:
a processor,
wherein the processor is configured to:
in a case where a recording medium is inserted,
acquire second information related to an attribute of the recording medium; and
restrict a first imaging mode related to a function of the imaging apparatus based on the second information.

20. The imaging apparatus according to claim 19,
wherein the attribute includes either a first attribute assigned to the recording medium by executing the first imaging mode or a second attribute assigned to data of the recording medium in association with a history record.

21. An imaging method comprising:
via a processor of an imaging apparatus,
acquiring first information related to insertion or removal of a recording medium on which imaging data of the imaging apparatus is recorded; and
restricting a first imaging mode related to a function of the imaging apparatus based on the first information.

22. A non-transitory computer readable medium for storing an imaging program, the program causing a processor of an imaging apparatus to execute a process comprising:
acquiring first information related to insertion or removal of a recording medium on which imaging data of the imaging apparatus is recorded; and
restricting a first imaging mode related to a function of the imaging apparatus based on the first information.
